(19) United States
(12) Patent Application Publication
(10) Pub. No.: US 2025/0184821 A1
(43) Pub. Date: Jun. 5, 2025

(54) SYSTEM AND METHOD TO USE WIFI AS BACKUP FOR CBRS PRIVATE 5G NETWORK

(71) Applicant: DISH Wireless L.L.C., Englewood, CO (US)

(72) Inventors: Mehdi Alasti, Arlington, VA (US); Kazi Bashir, Lewisville, TX (US); Siddhartha Chenumolu, Broadlands, VA (US)

(21) Appl. No.: 18/525,797

(22) Filed: Nov. 30, 2023

(51) Int. Cl. H04W 28/08; H04W 28/082; H04W 76/15

(52) U.S. Cl. CPC H04W 28/0846; H04W 28/082; H04W 76/15

(57) ABSTRACT

Systems and methods to use Wi-Fi as backup for CBRS private 5G network. One such method includes: using Access Traffic Steering, Switching and Splitting (ATSSS) User Equipment Route Selection Policy (URSP) to map a first portion of traffic to 3GPP Citizens Broadband Radio Service (CBRS) 5G access and to map a second portion of traffic to non-3GPP Wi-Fi access; creating a Multi-Access Protocol Data Unit (MA-PDU) session using ATSSS between a User Plane Function (UPF) and User equipment (UE) through the 3GPP CBRS 5G access and the non-3GPP Wi-Fi access; implementing ATSSS load balancing to control traffic congestion between the 3GPP CBRS 5G access and the non-3GPP Wi-Fi access; and initiating one of a plurality of ATSSS steering modes to define a primary access network and a backup access network, wherein, in response to the primary access network becoming unavailable, the system automatically switches to the backup access network.

### BACKGROUND

As the use of smartphones and Internet of Things (IoT) devices has increased, so too has the desire for more reliable, fast, and continuous transmission of content. In an effort to improve the content transmission, networks continue to improve with faster speeds and increased bandwidth. The advent and implementation of fifth-generation (5G) wireless technology has resulted in faster speeds and increased bandwidth. Thus, minimizing interruptions in the supporting networking infrastructure is important to providing a resilient and stable network with the desired end-to-end performance. It is with respect to these and other considerations that the embodiments described herein have been made.

### BRIEF SUMMARY

The present disclosure relates generally to telecommunication networks, more particularly, to the System and Method of using Wi-Fi as backup for CBRS private 5G network. The frequency band for CBRS in the United States is referred to as n48 in the 3GPP standards.

Briefly stated, one or more methods of using Wi-Fi as backup for CBRS private 5G network are disclosed. Some such methods include: using Access Traffic Steering, Switching and Splitting (ATSSS) User Equipment Route Selection Policy (URSP) to map a first portion of traffic to 3GPP Citizens Broadband Radio Service (CBRS) 5G access and to map a second portion of traffic to non-3GPP Wi-Fi access; creating a Multi-Access Protocol Data Unit (MA-PDU) session using ATSSS between a User Plane Function (UPF) and User equipment (UE) through the 3GPP CBRS 5G access and the non-3GPP Wi-Fi access; implementing ATSSS load balancing to control traffic congestion between the 3GPP CBRS 5G access and the non-3GPP Wi-Fi access; and initiating one of a plurality of ATSSS steering modes to define a primary access network and a backup access network, wherein, in response to the primary access network becoming unavailable, the traffic automatically switches to the backup access network to maintain operation, and wherein, in response to the primary access network becoming available again, the traffic maps back to the primary access network.

In some embodiments of the method for using Wi-Fi as backup for CBRS private 5G network, the traffic for Ultra-Reliable Low Latency Communications (URLLC) and Internet of Things (IoT) is mapped to 3GPP CBRS 5G access. In another aspect of some embodiments, the traffic for voice communications and Short Message Service (SMS) is mapped to non-3GPP Wi-Fi access. In still another aspect of some embodiments, the MA-PDU session is created using ATSSS between a UPF and UE through the 3GPP CBRS 5G access and the non-3GPP Wi-Fi access with a Multipath Transmission Control Protocol (MP-TCP), a Multipath Quick User Datagram Protocol (MP-QUIC), or Access Traffic Steering, Switching and Splitting lower layer (ATSSS-LL) functionalities. In yet another aspect of some embodiments, the Multipath QUIC multiplexes application streams on a single UDP flow, and MP-TCP splits a single stream on multiple TCP subflows.

Additionally, in some embodiments of the method for using Wi-Fi as backup for CBRS private 5G network, the ATSSS steering mode is used to load balance traffic for congestion control between CBRS 5G access and Wi-Fi access. In another aspect of some embodiments, the plurality of ATSSS steering modes includes active-standby, smallest delay, and priority based. In still another aspect of some embodiments, the primary access network is the CBRS 5G access and the backup access network is the Wi-Fi access. In yet another aspect of some embodiments, the non-3GPP Wi-Fi access connects to the primary access point via a Non-3GPP InterWorking Function (N3IWF) that acts as a secure gateway with support for N2 and N3 interfaces.

In one or more embodiments of a system for using Wi-Fi as backup for CBRS private 5G network, the system includes a memory that stores computer-executable instructions and a processor that executes the computer-executable instructions. When the computer instructions are executed by the one or more processors, it causes the system to: use Access Traffic Steering, Switching and Splitting (ATSSS) User Equipment Route Selection Policy (URSP) to map a first portion of traffic to 3GPP Citizens Broadband Radio Service (CBRS) 5G access and to map a second portion of traffic to non-3GPP Wi-Fi access; create a Multi-Access Protocol Data Unit (MA-PDU) session using ATSSS between a User Plane Function (UPF) and User equipment (UE) through the 3GPP CBRS 5G access and the non-3GPP Wi-Fi access; implement ATSSS load balancing to control traffic congestion between the 3GPP CBRS 5G access and the non-3GPP Wi-Fi access; and initiate one of a plurality of ATSSS steering modes to define a primary access network and a backup access network, wherein, in response to the primary access network becoming unavailable, the traffic automatically switches to the backup access network to maintain operation, and wherein, in response to the primary access network becoming available again, the traffic maps back to the primary access network.

In some embodiments, the traffic for Ultra-Reliable Low Latency Communications (URLLC) and Internet of Things (IoT) is mapped to 3GPP CBRS 5G access. In another aspect of some embodiments, the traffic for voice communications and Short Message Service (SMS) is mapped to non-3GPP Wi-Fi access. In still another aspect of some embodiments, the MA-PDU session is created using ATSSS between a UPF and UE through the 3GPP CBRS 5G access and the non-3GPP Wi-Fi access with a Multipath Transmission Control Protocol (MP-TCP), a Multipath Quick User Datagram Protocol (MP-QUIC), or Access Traffic Steering, Switching and Splitting lower layer (ATSSS-LL) functionalities. In yet another aspect of some embodiments, the Multipath QUIC multiplexes application streams on a single UDP flow, and MP-TCP splits a single stream on multiple TCP subflows.

Additionally, in some embodiments of the system for using Wi-Fi as backup for CBRS private 5G network, the ATSSS steering mode is used to load balance for traffic for congestion control between CBRS 5G access and Wi-Fi access. In another aspect of some embodiments, the plurality of ATSSS steering modes include active-standby, smallest delay, and priority based. In still another aspect of some embodiments, the primary access network is the CBRS 5G access and the backup access network is the Wi-Fi access. In yet another aspect of some embodiments, the non-3GPP Wi-Fi access connects to the primary access point via a Non-3GPP InterWorking Function (N3IWF) that acts as a secure gateway with support for N2 and N3 interfaces.

Additionally, in other embodiments, one or more non-transitory computer-readable storage mediums are disclosed. The one or more non-transitory computer-readable storage mediums have computer-executable instructions stored thereon that, when executed by at least one processor, cause the at least one processor to: use Access Traffic Steering, Switching and Splitting (ATSSS) User Equipment Route Selection Policy (URSP) to map a first portion of traffic to 3GPP Citizens Broadband Radio Service (CBRS) 5G access and to map a second portion of traffic to non-3GPP Wi-Fi access; create a Multi-Access Protocol Data Unit (MA-PDU) session using ATSSS between a User Plane Function (UPF) and User equipment (UE) through the 3GPP CBRS 5G access and the non-3GPP Wi-Fi access; implement ATSSS load balancing to control traffic congestion between the 3GPP CBRS 5G access and the non-3GPP Wi-Fi access; and initiate one of a plurality of ATSSS steering modes to define a primary access network and a backup access network, wherein, in response to the primary access network becoming unavailable, the traffic automatically switches to the backup access network to maintain operation, and wherein, in response to the primary access network becoming available again, the traffic maps back to the primary access network.

In some embodiments, the traffic for Ultra-Reliable Low Latency Communications (URLLC) and Internet of Things (IoT) is mapped to 3GPP CBRS 5G access. In another aspect of some embodiments, the traffic for voice communications and Short Message Service (SMS) is mapped to non-3GPP Wi-Fi access. In still another aspect of some embodiments, the MA-PDU session is created using ATSSS between a UPF and UE through the 3GPP CBRS 5G access and the non-3GPP Wi-Fi access with a Multipath Transmission Control Protocol (MP-TCP), a Multipath Quick User Datagram Protocol (MP-QUIC), or Access Traffic Steering, Switching and Splitting lower layer (ATSSS-LL) functionalities. In yet another aspect of some embodiments, the Multipath QUIC multiplexes application streams on a single UDP flow, and MP-TCP splits a single stream on multiple TCP subflows.

Additionally, in some embodiments of the system for using Wi-Fi as backup for CBRS private 5G network, the ATSSS steering mode is used to load balance for traffic for congestion control between CBRS 5G access and Wi-Fi access. In another aspect of some embodiments, the plurality of ATSSS steering modes include active-standby, smallest delay, and priority based. In still another aspect of some embodiments, the primary access network is the CBRS 5G access and the backup access network is the Wi-Fi access. In yet another aspect of some embodiments, the non-3GPP Wi-Fi access connects to the primary access point via a Non-3GPP InterWorking Function (N3IWF) that acts as a secure gateway with support for N2 and N3 interfaces.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the disclosed invention, reference will be made to the following Detailed Description, which is to be read in association with the accompanying drawings.

FIG. 1 illustrates a context diagram of a 5G network, which may be implemented in accordance with embodiments described herein.

FIG. 2 illustrates a diagram of an example system architecture overview of a system in which the environment of FIG. 1, may be implemented in accordance with embodiments described herein.

FIG. 3 illustrates a diagram showing connectivity between certain telecommunication network components during cellular telecommunication.

FIG. 4 illustrates a diagram showing System to use Wi-Fi as backup for CBRS private 5G network.

FIG. 5 illustrates a diagram showing 5G ATSSS Architecture as backup for CBRS private 5G network.

FIG. 6 illustrates a diagram showing 5G ATSSS Configured to Make Wi-Fi a Backup Network.

FIG. 7 is a logic diagram showing a method to use Wi-Fi as backup for CBRS private 5G network.

FIG. 8 shows a system diagram that describes an example implementation of a computing system(s) for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

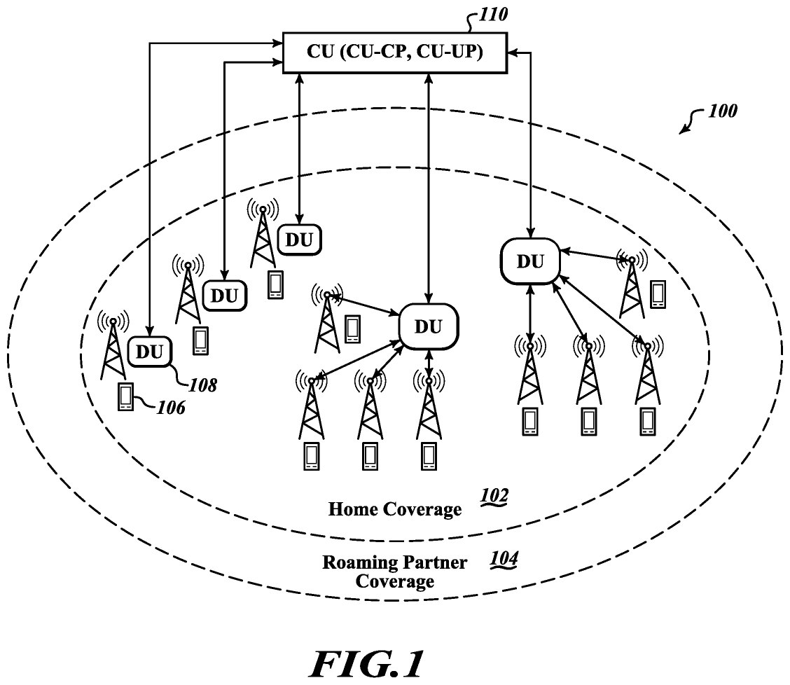

5G architecture provides an environment in which the system for System to use Wi-Fi as backup for CBRS private 5G network may be implemented. The following paragraphs disclose some 5G concepts and elements that support an ATSSS system for using Wi-Fi as backup for CBRS private 5G network, which will be further described below with reference to FIG. 1-8.

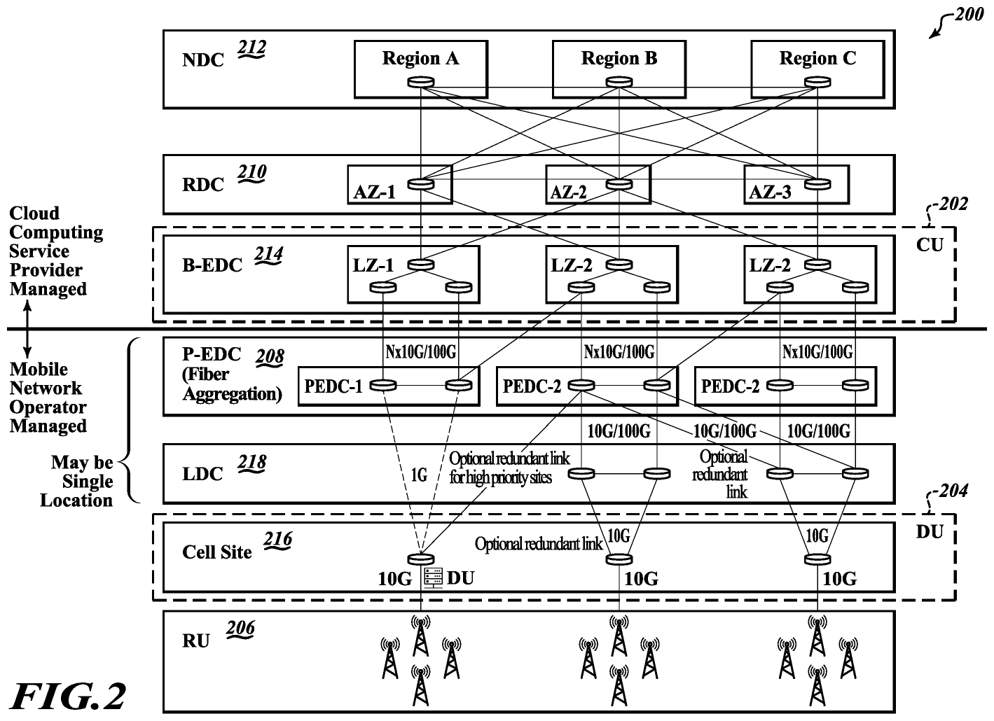

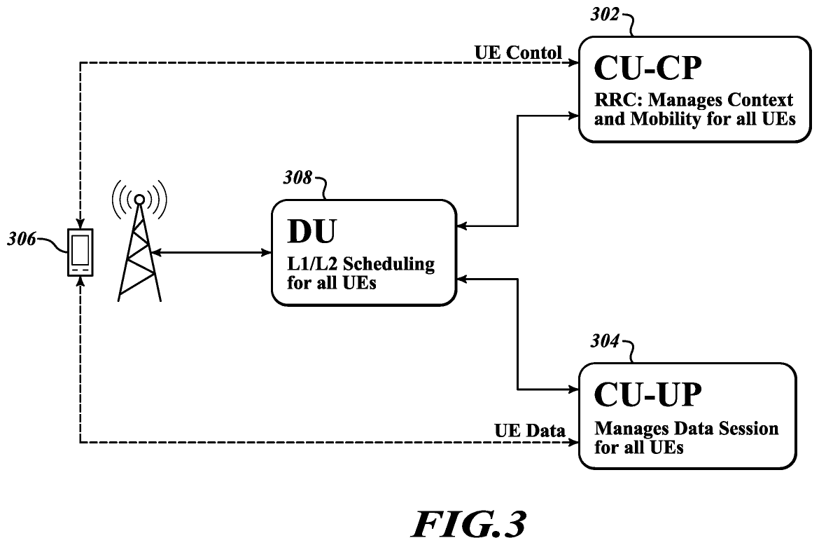

FIGS. 1-3 illustrate various aspects of a 5G environment that is described below with respect to a system in which 5G ATSSS is configured to make a Wi-Fi backup access for private CBRS 5G access. For example, FIG. 1 illustrates a context diagram of connects between various towers, DUs (Distributed Units), CUs (Centralized Units), and UEs (User Devices). FIG. 2 illustrates a diagram of an example system architecture overview that includes an NDC (National Data Center), RDC (Regional Data Center), B-EDC (Breakout Edge Data Centers), P-EDC (Passthrough Edge Data Centers), LDC (Local Data Center), cell sites, and RUs (Radio Units). FIG. 3 illustrates a diagram showing UE controls for managing context and mobility for UEs and UE data for managing data session of UEs.

5G provides a broad range of wireless services delivered to the end user across multiple access platforms and multi-layer networks. 5G is a dynamic, coherent and flexible framework of multiple advanced technologies supporting a variety of applications. 5G utilizes an intelligent architecture, with Radio Access Networks (RANs) not constrained by base station proximity or complex infrastructure. 5G enables a disaggregated, flexible, and virtual RAN with interfaces creating additional data access points.

5G network functions may be completely software-based and designed as cloud-native, meaning that they are agnostic to the underlying cloud infrastructure, allowing higher deployment agility and flexibility.

5G Core establishes reliable, secure connectivity to the network for end users and provides access to its services. 5G Core handles mobile network functions including connectivity, mobility management, authentication, subscriber data management, and policy management. 5G Core network functions are software-based and cloud-native, such that they may be used with various underlying cloud infrastructures.

With the advent of 5G, industry experts defined how the 5G Core (5GC) network should evolve to support the needs of 5G New Radio (NR) and the advanced use cases enabled by it. The 3rd Generation Partnership Project (3GPP) develops protocols and standards for telecommunication technologies including RAN, core transport networks and service capabilities. 3GPP has provided complete system specifications for 5G network architecture which is much more service oriented than previous generations.

Multi-Access Edge Computing (MEC) is an important element of 5G architecture. MEC is an evolution in telecommunications that brings the applications from centralized data centers to the network edge, and therefore closer to the end users and their devices. This essentially creates a shortcut in content delivery between the user and host, and the long network path that once separated them.

This MEC technology is not exclusive to 5G but is certainly important to its efficiency. Characteristics of the MEC include the low latency, high bandwidth and real time access to RAN information that distinguishes 5G architecture from its predecessors. This convergence of the RAN and core networks enables operators to leverage new approaches to network testing and validation. 5G networks based on the 3GPP 5G specifications provide an environment for MEC deployment. The 5G specifications define the enablers for edge computing, allowing MEC and 5G to collaboratively route traffic. In addition to the latency and bandwidth benefits of the MEC architecture, the distribution of computing power better enables the high volume of connected devices inherent to 5G deployment and the rise of IoT.

The 3rd Generation Partnership Project (3GPP) develops protocols for mobile telecommunications and has developed a standard for 5G. The 5G architecture is based on what is called a Service-Based Architecture (SBA), which leverages IT development principles and a cloud-native design approach. In this architecture, each network function (NF) offers one or more services to other NFs via Application Programming Interfaces (API). Network function virtualization (NFV) decouples software from hardware by replacing various network functions such as firewalls, load balancers and routers with virtualized instances running as software. This eliminates the need to invest in many expensive hardware elements and can also accelerate installation times, thereby providing revenue generating services to the customer faster.

NFV enables the 5G infrastructure by virtualizing appliances within the 5G network. This includes the network slicing technology that enables multiple virtual networks to run simultaneously. NFV may address other 5G challenges through virtualized computing, storage, and network resources that are customized based on the applications and customer segments. The concept of NFV extends to the RAN through, for example, network disaggregation promoted by alliances such as O-RAN. This enables flexibility and, provides open interfaces and open-source development, ultimately to case the deployment of new features and technology with scale. The O-RAN ALLIANCE objective is to allow multi-vendor deployment with off-the shelf hardware for the purposes of easier and faster inter-operability. Network disaggregation also allows components of the network to be virtualized, providing a means to scale and improve user experience as capacity grows. The benefits of virtualizing components of the RAN provide a means to be more cost effective from a hardware and software viewpoint especially for IoT applications where the number of devices is in the millions.

The 5G New Radio (5G NR) RAN comprises a set of radio base stations (each known as Next Generation Node B (gNB)) connected to the 5G Core (5GC) and to each other. The gNB incorporates three main functional modules: the Centralized Unit (CU), the Distributed Unit (DU), and the Radio Unit (RU), which can be deployed in multiple combinations. The primary interface is referred to as the F1 interface between DU and CU and are interoperable across vendors. The CU may be further disaggregated into the CU user plane (CU-UP) and CU control plane (CU-CP), both of which connect to the DU over F1-U and F1-C interfaces respectively. This 5G RAN architecture is described in 3GPP TS 38.401 V16.8.0 (2021 December). Each network function (NF) is formed by a combination of small pieces of software code called microservices.

A virtual private cloud (VPC) is a configurable pool of shared resources allocated within a public cloud environment. The VPC provides isolation between one VPC user and all other users of the same cloud, for example, by allocation of a private IP subnet and a virtual communication construct (e.g., a VLAN or a set of encrypted communication channels) per user. In some embodiments, this 5G network leverages the distributed nature of 5G cloud-native network functions and cloud flexibility, which optimizes the placement of 5G network functions for optimal performance based on latency, throughput and processing requirements.

In some embodiments, the network architecture utilizes a logical hierarchical architecture consisting of National Data Centers (NDCs), Regional Data Centers (RDCs) and Breakout Edge Data Centers (BEDCs), to accommodate the distributed nature of 5G functions and the varying requirements for service layer integration. In one or more embodiments, BEDCs are deployed in Local Zones hosting 5G NFs that have strict latency budgets. They may also be connected with Passthrough Edge Data Centers (PEDC), which serve as an aggregation point for all Local Data Centers (LDCs) and cell sites in a particular market. BEDCs also provide internet peering for 5G data service.

In one or more embodiments, an O-RAN network may be implemented that includes an RU (Radio Unit), which is deployed on towers and a DU (Distributed Unit), which controls the RU. These units interface with the Centralized Unit (CU), which is hosted in the BEDC at the Local Zone. These combined pieces provide a full RAN solution that handles all radio level control and subscriber data traffic.

In some embodiments, the User Plane Function (Data Network Name (DNN)) is collocated in the BEDC, which anchors user data sessions and routes to the internet. In another aspect, the BEDCs leverage local internet access available in Local Zones, which allows for a better user experience while optimizing network traffic utilization.

In one or more embodiments, the Regional Data Centers (RDCs) are hosted in the Region across multiple availability zones. The RDCs host 5G subscribers' signaling processes such as authentication and session management as well as voice for 5G subscribers. These workloads can operate with relatively high latencies, which allows for a centralized deployment throughout a region, resulting in cost efficiency and resiliency. For high availability, multiple RDCs are deployed in a region, each in a separate Availability Zone (AZ) to ensure application resiliency and high availability.

In another aspect of some embodiments, an AZ is one or more discrete data centers with redundant power, networking, and connectivity in a Region. In some embodiments, AZs in a Region are interconnected with high-bandwidth and low-latency networking over a fully redundant, dedicated metro fiber, which provides high-throughput, low-latency networking between AZs.

Cloud Native Functions (CNFs) deployed in the RDC utilize a high-speed backbone to failover between AZs for application resiliency. CNFs like AMF and SMF, which are deployed in RDC, continue to be accessible from the BEDC in the Local Zone in case of an AZ failure. They serve as the backup CNF in the neighboring AZ and would take over and service the requests from the BEDC.

In this embodiment of a system in which 5G ATSSS is configured to make a Wi-Fi backup network for private CBRS 5G network, dedicated VPCs are implemented for each Data Center type (e.g., local data center, breakout edge data center, regional data center, national data center, and the like). In some such embodiments, the national data center VPC stretches across multiple Availability Zones (AZs). In another aspect of some embodiments, two or more AZs are implemented per region of the cloud computing service provider.

Some embodiments of the 5G Core network functions require support for advanced routing capabilities inside VPC and across VPCs (e.g., UPF, SMF and ePDG). These functions rely on routing protocols such as BGP for route exchange and fast failover (both stateful and stateless). To support these requirements, virtual routers are deployed on EC2 to provide connectivity within and across VPCs, as well as back to the on-prem network.

Referring again to FIG. 1, this figure illustrates a context diagram of an environment for a system in which 5G ATSSS is configured to make a Wi-Fi backup access for private CBRS 5G access, in accordance with embodiments described herein. A given area 100 will mostly be covered by two or more mobile network operators' wireless networks. Generally, mobile network operators have some roaming agreements that allow users to roam from home network to partner network under certain conditions, shown in FIG. 1 as home network coverage area 102 and roaming partner network coverage area 104. Operators may configure the mobile user's device, referred to herein as user equipment (UE), such as UE 106, with priority and a timer to stay on the home network coverage area 102 versus the roaming partner network coverage area 104. If a UE (e.g., UE 106) cannot find the home network coverage area 102, the UE will scan for a roaming network after a timer expiration (6 minutes, for example). This could have significant impact on customer experience in case of a catastrophic failure in the network. As shown in FIG. 1, a 5G RAN is split into DUs (e.g., DU 108) that manage scheduling of all the users and a CU that manages the mobility and radio resource control (RRC) state for all the UEs. The RRC is a layer within the 5G NR protocol stack. It exists only in the control plane, in the UE and in the gNB. The behavior and functions of RRC are governed by the current state of RRC. In 5G NR, RRC has three distinct states: RRC_IDLE, RRC_CONNECTED and RRC_INACTIVE

FIG. 2 illustrates a diagram of an example system architecture overview 200 of a system in which 5G ATSSS is configured to make a Wi-Fi backup access for private CBRS 5G access in which the environment of FIG. 1 may be implemented in accordance with embodiments described herein. As shown in FIG. 2, the radio unit (RU) 206 converts radio signals sent to and from the antenna into a digital signal for transmission over packet networks. It handles the digital front end (DFE) and the lower physical (PHY) layer, as well as the digital beamforming functionality.

The DU 204 may sit close to the RU 206 and runs the radio link control (RLC), the Medium Access Control (MAC) sublayer of the 5G NR protocol stack, and parts of the PHY layer. The MAC sublayer interfaces to the RLC sublayer from above and to the PHY layer from below. The MAC sublayer maps information between logical and transport channels. Logical channels are about the type of information carried whereas transport channels are about how such information is carried. This logical node includes a subset of the gNB functions, depending on the functional split option, and its operation is controlled by the CU 202.

The CU 202 is the centralized unit that runs the RRC and Packet Data Convergence Protocol (PDCP) layers. A gNB may comprise a CU and one DU connected to the CU via F1-C and F1-U interfaces for control plane (CP) and user plane (UP), respectively. A CU with multiple DUs will support multiple gNBs. The split architecture enables a 5G network to utilize different distribution of protocol stacks between CU 202 and DU 204 depending on mid-haul availability and network design. The CU 202 is a logical node that includes the gNB functions like transfer of user data, mobility control, RAN sharing, positioning, session management, etc., with the exception of functions that may be allocated exclusively to the DU 204. The CU 202 controls the operation of several DUs 204 over the mid-haul interface.

As mentioned above, 5G network functionality is split into two functional units: the DU 204 is responsible for real time 5G layer 1 (L1) and 5G layer 2 (L2) scheduling functions, and the CU 202 is responsible for non-real time, higher L2 and 5G layer 3 (L3). As shown in FIG. 2, the DU's server and relevant software may be hosted on a cell site 216 itself or can be hosted in an edge cloud (local data center (LDC) 218 or central office) depending on transport availability and fronthaul interface. The CU's server and relevant software may be hosted in a regional cloud data center or, as shown in FIG. 2, in a breakout edge data center (B-EDC) 214. As shown in FIG. 2, the DU 204 may be provisioned to communicate via a pass-through edge data center (P-EDC) 208. The P-EDC 208 may provide a direct circuit fiber connection from the DU directly to the primary cloud availability zone (e.g., B-EDC 214) hosting the CU 202. In some embodiments, the LDC 218 and P-EDC 208 may be co-located or in a single location. The CU 202 may be connected to a regional cloud data center (RDC) 210, which in turn may be connected to a national cloud data center (NDC) 212. In the example embodiment, the P-EDC 208, the LDC 218, the cell site 216 and the RU 206 may all be managed by the mobile network operator and the B-EDC 214, the RDC 210 and the NDC 212 may all be managed by a cloud computing service provider. According to various embodiments, the actual split between DU and RU may be different depending on the specific use-case and implementation.

FIG. 3 is a diagram showing connectivity between certain telecommunication network components with respect to a system (e.g., a system in which 5G ATSSS is configured to make a Wi-Fi backup access for private CBRS 5G access). The central unit control plane (CU-CP) 302, for example, of CU 110 of FIG. 1 or CU 202 of FIG. 2, primarily manages control processing of DUs, such as DU 308, and UEs, such as UE 306. The CU-CP 302 hosts RRC and the control-plane part of the PDCP protocol. CU-CP 302 manages the mobility and radio resource control (RRC) state for all the UEs. The RRC is a layer within the 5G NR protocol stack and manages context and mobility for all UEs. The behavior and functions of RRC are governed by the current state of RRC. In 5G NR, RRC has three distinct states: RRC_IDLE, RRC_CONNECTED and RRC_INACTIVE. The CU-CP 302 terminates the E1 interface connected with the central unit user plane (CU-UP) 304 and the F1-C interface connected with the DU 308. The DU 308 maintains a constant heartbeat with CU-CP 302. The CU-UP 304 manages the data sessions for all UEs 306 and hosts the user plane part of the PDCP protocol. The CU-UP 304 terminates the E1 interface connected with the CU-CP and the F1-U interface connected with the DU 308.

A virtual private cloud is a configurable pool of shared resources allocated within a public cloud environment. The VPC provides isolation between one VPC user and all other users of the same cloud, for example, by allocation of a private IP subnet and a virtual communication construct (e.g., a VLAN or a set of encrypted communication channels) per user. In some embodiments, this 5G network leverages the distributed nature of 5G cloud-native network functions and cloud flexibility, which optimizes the placement of 5G network functions for optimal performance based on latency, throughput and processing requirements.

In some embodiments, the network architecture utilizes a logical hierarchical architecture consisting of National Data Centers (NDCs), Regional Data Centers (RDCs) and Breakout Edge Data Centers (BEDCs), to accommodate the distributed nature of 5G functions and the varying requirements for service layer integration. In one or more embodiments, BEDCs are deployed in Local Zones hosting 5G NFs that have strict latency budgets. They may also be connected with Passthrough Edge Data Centers (PEDC), which serve as an aggregation point for all Local Data Centers (LDCs) and cell sites in a particular market. BEDCs also provide internet peering for 5G data service.

In one or more embodiments, an O-RAN network may be implemented that includes an RU (Radio Unit), which is deployed on towers and a DU (Distributed Unit), which controls the RU. These units interface with the Centralized Unit (CU), which is hosted in the BEDC at the Local Zone. These combined pieces provide a full RAN solution that handles all radio level control and subscriber data traffic.

In some embodiments, the User Plane Function (Data Network Name (DNN)) is collocated in the BEDC, which anchors user data sessions and routes to the internet. In another aspect, the BEDCs leverage local internet access available in Local Zones, which allows for a better user experience while optimizing network traffic utilization.

In one or more embodiments, the Regional Data Centers (RDCs) are hosted in the Region across multiple availability zones. The RDCs host 5G subscribers' signaling processes such as authentication and session management as well as voice for 5G subscribers. These workloads can operate with relatively high latencies, which allows for a centralized deployment throughout a region, resulting in cost efficiency and resiliency. For high availability, multiple RDCs are deployed in a region, each in a separate Availability Zone (AZ) to ensure application resiliency and high availability.

In another aspect of some embodiments, an AZ is one or more discrete data centers with redundant power, networking, and connectivity in a Region. In some embodiments, AZs in a Region are interconnected with high-bandwidth and low-latency networking over a fully redundant, dedicated metro fiber, which provides high-throughput, low-latency networking between AZs.

Cloud Native Functions (CNFs) deployed in the RDC utilize a high-speed backbone to failover between AZs for application resiliency. CNFs like AMF and SMF, which are deployed in RDC, continue to be accessible from the BEDC in the Local Zone in case of an AZ failure. They serve as the backup CNF in the neighboring AZ and would take over and service the requests from the BEDC.

In this embodiment of the system in which 5G ATSSS is configured to make a Wi-Fi backup access for private CBRS 5G access, dedicated VPCs are implemented for each Data Center type (e.g., local data center, breakout edge data center, regional data center, national data center, and the like). In some such embodiments, the national data center VPC stretches across multiple Availability Zones (AZs). In another aspect of some embodiments, two or more AZs are implemented per region of the cloud computing service provider.

Some embodiments of the 5G Core network functions require support for advanced routing capabilities inside VPC and across VPCs (e.g., UPF, SMF and ePDG). These functions rely on routing protocols such as BGP for route exchange and fast failover (both stateful and stateless). To support these requirements, virtual routers are deployed on EC2 to provide connectivity within and across VPCs, as well as back to the on-prem network.

### Private CBRS 5G Network

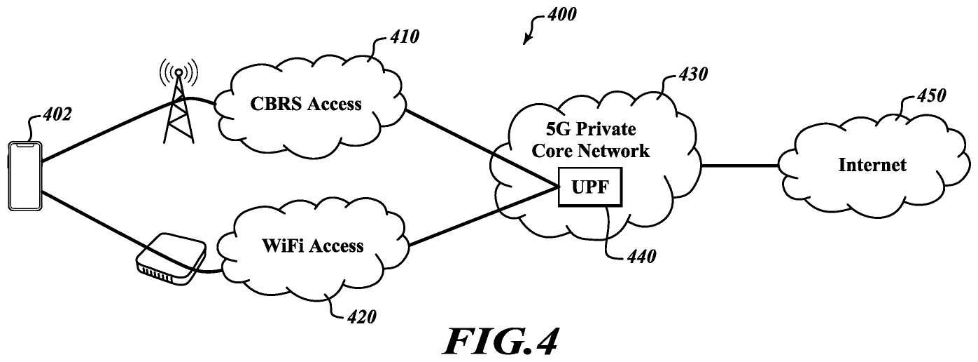

Referring now to FIG. 4, some embodiments of a 5G network architecture include a System to use Wi-Fi as backup for Citizens Broadband Radio Service (CBRS) Private 5G network. The 3rd Generation Partnership Project (3GPP), which is an umbrella term for a number of standards organizations that develop protocols for mobile telecommunications, has specified a non-public network (NPN) framework to be used for private networks, e.g., enterprises. In the 5G NPN model, an enterprise can either own their standalone private network (S-NPN), or a Public Land Mobile Network (PLMN) can provide their network, e.g., a network slice, such as a Public Network Integrated Non-Public Network (PNI-NPN). A PNI-NPN is supported using network slices, Closed Access Group (CAG) cells, or both.

In some embodiments, a public cloud provider (e.g., Amazon Web Services (AWS)) enables enterprises to instantiate their network functions (NFs) in the cloud. The FCC has specified certain spectrum sharing rules over the CBRS band (3.5 GHZ) for the incumbent user, which include Priority Access License (PAL) and General Authorized Access (GAA). Thus, some enterprises use the CBRS band as a GAA to build their private network based on S-NPN model. Although the CBRS spectrum sharing model is extremely useful for the enterprises, a GAA must leave the spectrum anytime an incumbent or a PAL is requesting the spectrum. Additionally, a GAA cannot use the spectrum until it is allowed to according to the spectrum sharing rules. Notably, the CBRS spectrum may not be available for the enterprise that is using GAA for hours. Accordingly, there is a significant requirement for backup access to enable the enterprise to continue its operation anytime the CBRS spectrum is not available. This need for backup access when the CBRS spectrum is not available is a technological challenge to be overcome.

As shown in FIG. 4, in some embodiments of the disclosed system 400, User Equipment (UE) 402 connects to both a CBRS 5G access 410 and a non-3GPP (e.g., Wi-Fi) access 420. Both the CBRS 5G access 410 and a non-3GPP (e.g., Wi-Fi) access 420 connect to a 5G Private Core Network 430 at User Plane Function (UPF) 440. The 5G Private Core Network 430 in turn connects to the Internet 450. In one or more embodiments, the non-3GPP (e.g., Wi-Fi) access 420 not only acts as a companion link for the CBRS 5G access 410 (e.g., where it enables enterprise traffic to be balanced between the two access links), the non-3GPP (e.g., Wi-Fi) access 420 also provides backup access for the CBRS 5G access 410, anytime CBRS is temporarily unavailable. Notably, 3GPP allows the 5G Private Core Network 430 to connect to both 3GPP 5G NR RAN, as well as non-3GPP (Wi-Fi) access point (e.g., through Evolved Packet Data Gateway (cPDG) or Non-3GPP Interworking Function (N3IWF)). In one or more embodiments of the disclosed system, the Access Traffic Steering-Switching-Splitting (ATSSS; Release-16) is implemented to enable a private network to employ non-3GPP (e.g., Wi-Fi) access 420 as the backup network for their CBRS 5G access 410, anytime CBRS is temporarily unavailable.

Referring now to 5G ATSSS in further detail, 5G ATSSS allows both 3GPP access and non-3GPP access to be used simultaneously. For example, in an aspect of one embodiment, the Access Traffic Steering functionality of 5G ATSSS enables an access network (e.g., CBRS 5G access 410 and non-3GPP (Wi-Fi) access 420) to be selected for a data flow and routes the data flow traffic over the selected access network/link. Access Traffic Steering enables traffic to be steered between 5G or Wi-Fi to select the best network at that time. In another aspect of one embodiment, the Access Traffic Switching functionality of 5G ATSSS enables all traffic of a data flow to be moved from one access network/link (e.g., CBRS 5G access 410) to another access network/link (e.g., non-3GPP (Wi-Fi) access 420) while maintaining the session continuity. Access Traffic Switching enables traffic to be seamlessly handed over from 5G to Wi-Fi (and from Wi-Fi to 5G) as needed. In still another aspect of one embodiment, the Access Traffic Splitting functionality of 5G ATSSS enables a data flow traffic to be split across multiple access networks (e.g., CBRS 5G access 410 and non-3GPP (Wi-Fi) access 420). Access Traffic Splitting enables traffic to be aggregated between a 5G network and a Wi-Fi network as needed. Together, Access Traffic Steering, Access Traffic Switching, and Access Traffic Splitting result in improved multinetwork traffic flow and thus, improved end-user experience.

Referring now to another aspect of some embodiments, a Multi-Access (MA) Packet Data Unit (PDU) session in implemented in which traffic is routed over one link (e.g., CBRS 5G access 410), over the other link (e.g., non-3GPP Wi-Fi access 420), or over both access links, simultaneously. In one embodiment, a MA-PDU session uses the ATSSS functionality of Multipath Transmission Control Protocol (MP-TCP) or multipath QUIC (MP-QUIC), e.g., ATSSS-HL, to distributed access traffic. MP-TCP is connection-oriented transport protocol that uses multiple paths to maximize throughput and increase redundancy. MP-TCP also enables a UE 402 to communicate with an MP-TCP proxy 544 in the UPF 440 to determine how TCP traffic associated with the applications can be steered, switched, and/or split. MP-QUIC is a deployable multipath transport protocol that enables hosts to exchange data over multiple networks using a single connection. In another embodiment, a MA-PDU session use the ATSSS functionality of ATSSS-lower layer (ATSSS-LL) to distributed access traffic. ATSSS-LL supports traffic aggregation of 3GPP and non-3GPP user plane paths, without any specific protocol between UE 402 and the UPF 440. In yet another aspect of some embodiments, Release-16 of 5G ATSSS includes features used by a private network to steer traffic to Wi-Fi access 420 when CBRS 5G access 410 access is unavailable.

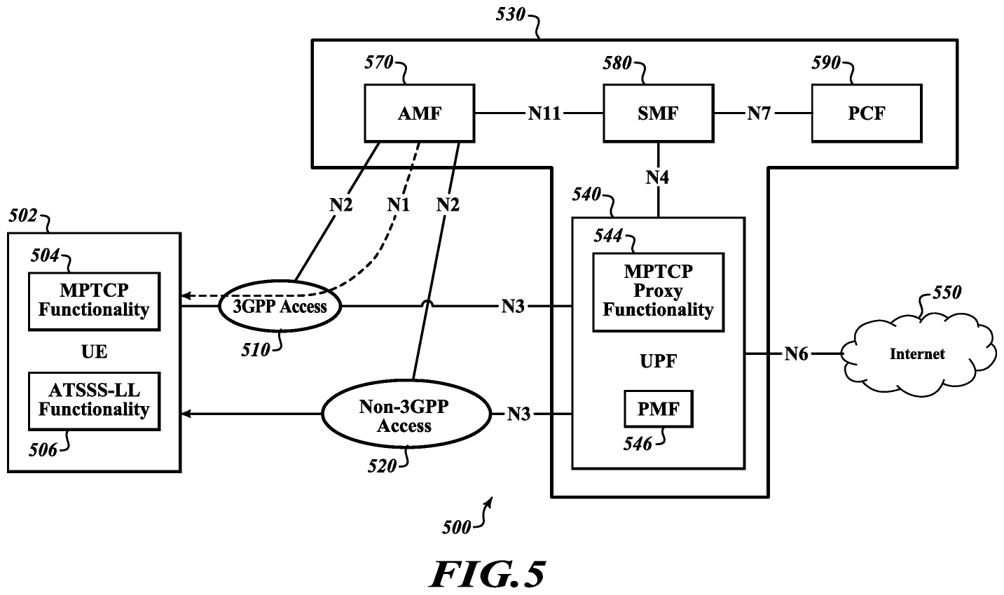

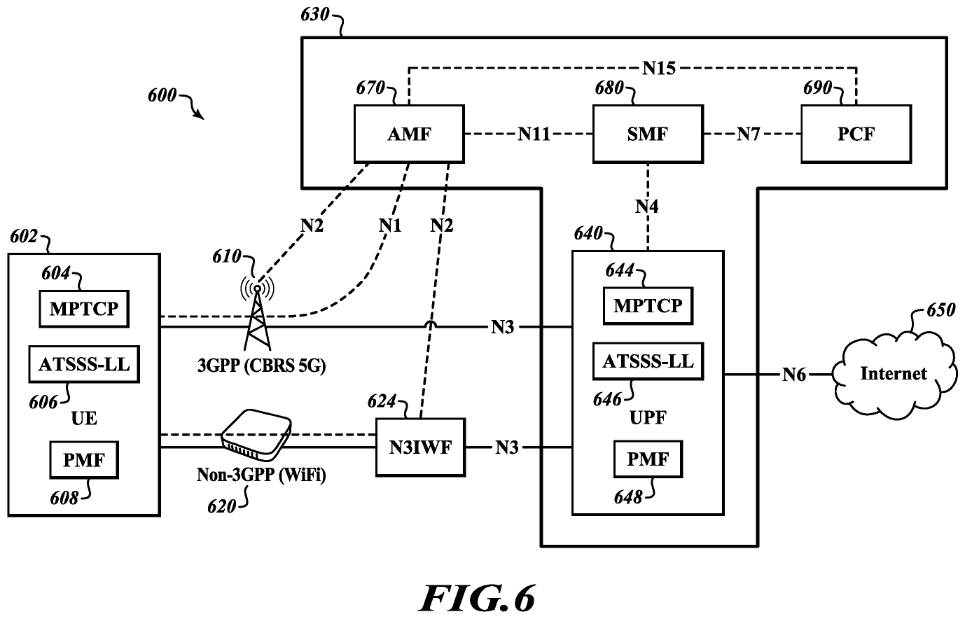

Referring now to FIG. 5, an embodiment of 5G ATSSS Architecture is shown. As displayed in FIG. 5, User Equipment (UE) 502 includes Multipath Transmission Control Protocol (MP-TCP) functionality 504 and ATSSS-LL functionality 506. Notably, the UE 106 in FIG. 1, UE 306 in FIG. 3, UE 402 in FIG. 4, UE 502 in FIG. 5, and UE 602 in FIG. 6, all represent the same type of User Equipment, albeit in at least somewhat differently displayed environments. The UE 502 connects via a CBRS 5G access 510 and a non-3GPP (Wi-Fi) access 520 to a 5G Core Network 530. The 5G Core Network 530 includes a User Plane Function (UPF) 540, an Access and Mobility Function (AMF) 570, a Session Management Function (SMF) 580, and a Policy Control Function (PCF) 590. The User Plane Function (UPF) 540 includes MP-TCP proxy functionality 544 and Performance Measurement Function (PMF) 546. The UPF 540 is the packet gateway transporting data to the Internet 550. Notably, the Internet (or other data network) 450 in FIG. 4, UE 550 in FIG. 5, and UE 650 in FIG. 6, all represent the same Internet (or other data network), albeit in at least somewhat differently displayed environments.

Within the 5G Core Network 530, the Policy Control Function (PCF) 590 supports ATSSS policy rule(s) and delivers to the ATSSS rules to the Access and Mobility Function (AMF) 570 and the Session Management Function (SMF) 580. The SMF 580 is part of Control Plane Function (CPF) (not shown) within 5G Core Network 530. The ATSSS rules (N11 from SMF 580 to AMF 570, and N1 from AMF 570 to UE 502) are shared with UE 502 for Uplink (UL) traffic, and are shared with UPF 540 (N4 from SMF 580 to UPF 540) for downlink (DL) traffic. To check the access availability and the latency, the Performance Measurement Function (PMF) 546 in the UPF 540 obtains access performance measurements over the user-plane of each access (e.g., CBRS 5G access 510 and a non-3GPP (Wi-Fi) access 520) between the UE 502 and UPF 540.

The N1 interface is a control plane interface between the UE 502 and the Access and Mobility Function (AMF) 570 in the 5G Core Network 530. The N1 interface is primarily used to transfer information about the connection, mobility, and session from the UE 502 to the AMF 570. The N2 interface is the control plane interface between the access networks (e.g., the CBRS 5G access network 510 and the non-3GPP (Wi-Fi) access network 520) and the AMF 570 in the 5G Core 530. The N2 interface is primarily used for connection management, UE context and Protocol Data Unit (PDU) session management, and UE mobility management. The N3 interface is the data plane interface between the access networks (e.g., the CBRS 5G access 510 and a non-3GPP (Wi-Fi) access 520) and the User Plane Function (UPF) 540 in the 5G Core 530.

The N4 Interface is the bridge between the Session Management Function (SMF) 580 of the Control Plane Function (CPF) and the User Plane Function (UPF) 540. The N6 Interface is the bridge between the User Plane Function (UPF) 540 and the Internet 550. The N7 Interface includes the Policy and Charging Configuration (PCC) rules that are generated by the ATSSS-enabled Policy Control Function (PCF) 590 and translated by the ATSSS-enabled Session Management Function (SMF) 580 into N4 rules for the UPF 540, and ATSSS rules (N11 interface used between SMP 580 and AMF 570) delivered via the Access and Mobility Management Function (AMF) 570 to the UE 502.

As the name imply ATSSS includes Access Traffic Steering functionality, Access Traffic Switching functionality, and Access Traffic Splitting functionality. In this regard, the Access Traffic Steering functionality of ATSSS includes several different steering modes, namely Active-Standby, Smallest delay, Load Balancing, and Priority based. Regarding the Active-Standby mode, in this mode the CBRS 5G access 510 is designated as Master and the Wi-Fi access 520 designated as Slave. In this mode, the private network traffic is always routed through the CBRS 5G access 510 unless it becomes temporarily unavailable. At such a time when the CBRS 5G access 510 is unavailable, the private network traffic is automatically routed through Wi-Fi access 520. This is the only steering mode available for Guaranteed Bit Rate (GBR) traffic sessions of the private network.

In one such example, the Traffic Descriptor is UDP, DestAddr A.B.C.D., and the Steering Mode is Active-Standby, Active=3GPP CBRS 5G, Standby=non-3GPP Wi-Fi. In such an embodiment, UDP traffic with destination IP address A.B.C.D. is steered to the active access (e.g., 3GPP CBRS 5G), if available. If the active access (e.g., 3GPP CBRS 5G) is not available, then UDP traffic is sent to the standby access (non-3GPP Wi-Fi).

Referring now to the Smallest delay mode, the access link (e.g., either CBRS 5G access 510 or Wi-Fi access 520) is selected that shows the lowest Round-Trip Time (RTT) at the moment of session initiation. During the session life, if that access link (e.g., CBRS 5G access 510) becomes unavailable, then the other access link (e.g., Wi-Fi access 520) is used, in a similar manner to Active-Standby.

In one such example, the Traffic Descriptor is TCP, DestPort 8080, and the Steering Mode is Smallest Delay. In such an embodiment, TCP traffic with destination port 8080 is steered to the access path with the smallest delay, as measure by the Performance Measurement Function (PMF) 546. Additionally, the RTT is measured over both CBRS 5G access and Wi-Fi access to determine which access has the smallest delay.

Referring now to the Load Balancing mode of the Access Traffic Steering functionality, in this mode a percent of the share between the two access links (e.g., CBRS 5G and Wi-Fi) is specified (e.g., 60%-40%, 70%-30%, 80%-20%, etc.). Notably, in the Load Balancing mode, if one of the two access links becomes unavailable, then the balancing of the enterprise traffic moves completely (i.e., 100%) to the other access link. In some embodiments, Load Balancing for the ATSSS may be performed by the PMF 546 in the UPF 540 as shown in FIG. 5. Alternatively, as shown in other embodiments in FIG. 6, Load Balancing for the ATSSS may be performed by both the PMF 608 in the UE 602 and by the PMF 648 in the UPF 640.

In one such example, the Traffic Descriptor is Application-1, and the Steering Mode is Load-Balancing, 3GPP=70%, non-3GPP=30%. In such an embodiment, the Steering Functionality is designated as MP-TCP. In this example, 70% of the traffic of Application-1 is routed over 3GPP CBRS 5G access, and 30% of the traffic is routed to non-3GPP Wi-Fi access using the MP-TCP functionality.

Referring now to the Priority based steering mode of the Access Traffic Steering functionality, in this mode one or more of the access paths is designated with a higher priority. The enterprise traffic is initially sent only to the access path marked with the higher priority (e.g., CBRS 5G access 510) until that access path becomes congested. Determination of what constitutes congestion may be defined by the enterprise. At that moment when a congestion determination has been reached, the traffic thereafter splits between both the higher priority access path (e.g., the CBRS 5G access 510) and the lower priority access path (e.g., the Wi-Fi access 520). If at any time the high priority access path (e.g., CBRS 5G access 510) becomes completely unavailable, then all of the traffic (i.e., 100%) is steered to the low priority access path (e.g., the Wi-Fi access 520).

In one or more embodiments, an ATSSS rule is implemented with a “match all” Traffic Descriptor. The “match all” Traffic Descriptor matches all Service Data Flows (SDFs). In one example, this ATSSS rule is applied last, and determines the default behavior for all the traffic not matching any of the previous steering rules described above.

Referring now to FIG. 6, an embodiment of 5G ATSSS Architecture is shown in which ATSSS is configured to Make a Wi-Fi Backup Network to a CBRS 5G primary Network. As displayed in FIG. 6, User Equipment (UE) 602 includes Multipath Transmission Control Protocol (MP-TCP) functionality 604, ATSSS-LL functionality 606, and a Performance Measurement Function (PMF) 608. The UE 602 connects via a CBRS 5G access 610 and a non-3GPP (Wi-Fi) access 620 to a 5G Core Network 630.

Specifically, the UE 602 connects to AMF 670 via CBRS 5G access 610. Additionally, the UE 602 connects to AMF 670 via non-3GPP (Wi-Fi) access 620 and Non-3GPP Interworking Function (N3IWF) 624. The N3IWF 624 acts as a secure gateway for non-3GPP access to the 5G Core Network 630 with support for N2 and N3 interfaces towards the 5G Core Network 630 (e.g., a N2 interface to Access and Mobility Function (AMF) 670 and a N3 interface to the User Plane Function (UPF) 640). Additionally, N3IWF 624 provides a secure connection for the UE 602 accessing the 5G Core Network 630 over a non-3GPP access network 620 with support for IP security between the UE 602 and the N3IWF 624.

The 5G Core Network 630 includes a User Plane Function (UPF) 640, an Access and Mobility Function (AMF) 670, a Session Management Function (SMF) 680, and a Policy Control Function (PCF) 690. The User Plane Function (UPF) 640 includes MP-TCP proxy functionality 644, ATSSS-LL functionality 646, and a Performance Measurement Function (PMF) 648. The UPF 640 is the packet gateway transporting data to the Internet 650. Notably, in the embodiment of 5G ATSSS Architecture in which Wi-Fi network is configured as a Backup Network to a CBRS 5G primary Network, both the UE 602 and the UPF 640 each include Multipath Transmission Control Protocol (MP-TCP) functionality 604 and 644, ATSSS-LL functionality 606 and 646, and a Performance Measurement Function (PMF) 608 and 648.

Within the 5G Core Network 630, the Policy Control Function (PCF) 690 supports ATSSS policy rule(s) and delivers to the ATSSS rules to the Access and Mobility Function (AMF) 670 and the Session Management Function (SMF) 680. The SMF 680 is part of Control Plane Function (CPF) within 5G Core Network 630. The ATSSS rules (N11 from SMF 680 to AMF 670, and N1 from AMF 670 to UE 602) are shared with UE 602 for Uplink (UL) traffic, and are shared with UPF 640 (N4 from SMF 680 to UPF 640) for downlink (DL) traffic. To check the access availability and the latency, the Performance Measurement Function (PMF) 608 in the UE 602, and PMF 648 in the UPF 640, obtain access performance measurements over the user-plane of each access (e.g., CBRS 5G access 610 and a non-3GPP (Wi-Fi) access 620) between the UE 602 and UPF 640.

The N1 interface is a control plane interface between the UE 602 and the Access and Mobility Function (AMF) 670 in the 5G Core Network 630. The N1 interface is primarily used to transfer information about the connection, mobility, and session from the UE 602 to the AMF 670. The N2 interface is the control plane interface between the access networks (e.g., the CBRS 5G access network 610 and the non-3GPP (Wi-Fi) access network 620) and the AMF 670 in the 5G Core 630. The N2 interface is primarily used for connection management, UE context and Protocol Data Unit (PDU) session management, and UE mobility management. The N3 interface is the data plane interface between the access networks (e.g., the CBRS 5G access network 610 and a non-3GPP (Wi-Fi) access network 620) and the User Plane Function (UPF) 640 in the 5G Core 630.

The N4 Interface is the bridge between the Session Management Function (SMF) 680 of the Control Plane Function (CPF) and the User Plane Function (UPF) 640. The N6 Interface is the bridge between the User Plane Function (UPF) 640 and the Internet 650. The N7 Interface includes the Policy and Charging Configuration (PCC) rules that are generated by the ATSSS-enabled Policy Control Function (PCF) 690 and translated by the ATSSS-enabled Session Management Function (SMF) 680 into N4 rules for the UPF 640, and ATSSS rules (N11 interface used between SMP 680 and AMF 670) delivered via the Access and Mobility Management Function (AMF) 670 to the UE 602. The N15 Interface is a reference point is between the PCF 690 and the AMF 670.

In one embodiment of the disclosed system, an enterprise utilizing CBRS 5G access 610 also utilizes Wi-Fi access 620 both as a companion network as well as a backup network, when the CBRS 5G access 610 is not available. In such an embodiment of the disclosed system, the enterprise uses ATSSS to manage traffic steering, switching, and splitting, as well as to configure Wi-Fi access 620 properly to act as a backup network when CBRS 5G access 610 is temporarily unavailable.

In some embodiments of a system in which 5G ATSSS is configured to make a Wi-Fi backup network for private CBRS 5G network, the system includes a memory that stores computer-executable instructions and a processor that executes the computer-executable instructions. The executed instructions causes the system to use ATSSS User Equipment Route Selection Policy (URSP) to map a first portion of enterprise traffic to a 3GPP CBRS 5G access 610 and to map a second portion of enterprise traffic to non-3GPP (e.g., Wi-Fi) access 620. Additionally, the executed instructions causes the system to create a MA-PDU session using ATSSS between a UPF 640 and UE 602 through the 3GPP CBRS 5G access 610 and the non-3GPP (e.g., Wi-Fi) access 620. Further, in some embodiments, the executed instructions cause the system to implement ATSSS load balancing to control traffic congestion between the 3GPP CBRS 5G access 610 and the non-3GPP (e.g., Wi-Fi) access 620. The executed instructions also causes the system to initiate one of a plurality of ATSSS steering modes to define a primary access network and a backup access network. Thus, in response to the primary access network becoming unavailable, the system automatically switches to the backup access network to maintain operation, and in response to the primary access network becoming available again, the traffic maps back to the primary access network.

In one or more embodiments of the system, the traffic for devices that use Ultra-Reliable Low Latency Communications (URLLC) and Internet of Things (IoT) is mapped to the 3GPP CBRS 5G access 610. Correspondingly, the traffic for devices that use voice communications and Short Message Service (SMS) is mapped to the non-3GPP Wi-Fi access 620. Notably, in some embodiments, the MA-PDU session is created using ATSSS between a UPF 640 and UE 602 through the 3GPP CBRS 5G access 610 and the non-3GPP Wi-Fi access 620 with MP-TCP 604 and/or ATSSS-LL 606.

In another aspect of some embodiments, MP-QUIC is used to multiplex application streams on a single UDP flow, and MP-TCP is used to split a single stream on multiple TCP subflows. In still another aspect, ATSSS steering mode is used to load balance traffic for congestion control between 3GPP CBRS 5G access 610 and non-3GPP Wi-Fi access 620. For example, in one embodiment, the load balance mode of the ATSSS steering functionality maps 70% of IoT traffic to 3GPP CBRS 5G access 610 and maps a remaining 30% of traffic to non-3GPP Wi-Fi access 620. Other ATSSS steering modes that may be implemented include active-standby steering mode, smallest delay steering mode, and priority based steering mode.

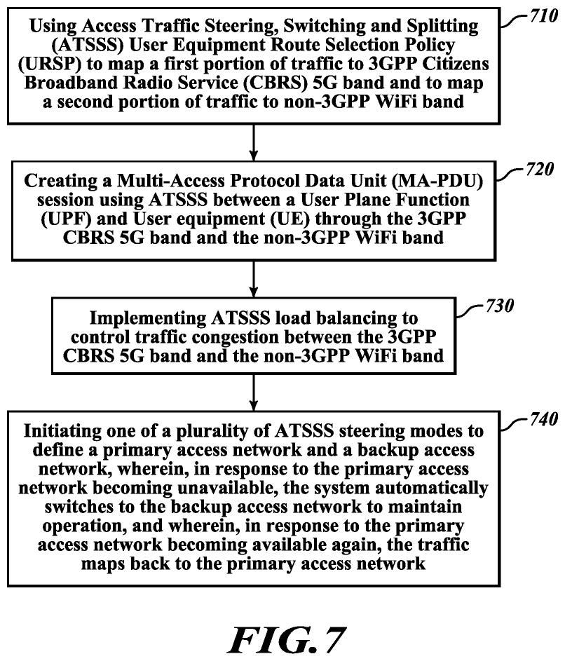

FIG. 7 is a logic diagram showing a method for 5G ATSSS Configured to Make a Wi-Fi Backup Network for private CBRS 5G network. This schedule method may be implemented a 5G architecture, such as has been shown in FIGS. 1-3 as described above. As shown in FIG. 7, at operation 710, the method includes using Access Traffic Steering, Switching and Splitting (ATSSS) User Equipment Route Selection Policy (URSP) to map a first portion of traffic to 3GPP Citizens Broadband Radio Service (CBRS) 5G access and to map a second portion of traffic to non-3GPP Wi-Fi access. At operation 720, the method includes creating a Multi-Access Protocol Data Unit (MA-PDU) session using ATSSS between a User Plane Function (UPF) and User equipment (UE) through the 3GPP CBRS 5G access and the non-3GPP Wi-Fi access. At operation 730, the method includes implementing ATSSS load balancing to control traffic congestion between the 3GPP CBRS 5G access and the non-3GPP Wi-Fi access. At operation 740, the method includes initiating one of a plurality of ATSSS steering modes to define a primary access network and a backup access network, wherein, in response to the primary access network becoming unavailable, the system automatically switches to the backup access network to maintain operation, and wherein, in response to the primary access network becoming available again, the traffic maps back to the primary access network.

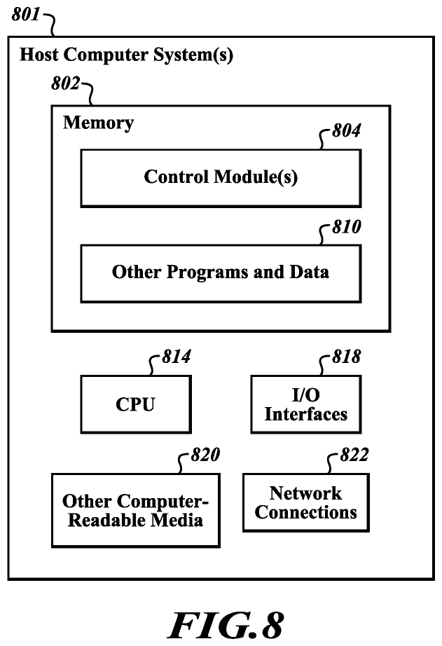

FIG. 8 shows a system diagram that describes an example implementation of a computing system(s) for implementing embodiments described herein. The functionality described herein for a system for 5G ATSSS Configured to Make a Wi-Fi Backup Network for private CBRS 5G network can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they're agnostic to the underlying cloud infrastructure, allowing higher deployment agility and flexibility. This proactive scheduling system may be implemented a 5G architecture, such as has been shown in FIGS. 1-3 as described above.

In particular, shown is example host computer system(s) 801. For example, such computer system(s) 801 may represent those in various data centers and gNBs shown and/or described herein that host the functions, components, microservices and other aspects described herein to implement a method for 5G ATSSS Configured to Make a Wi-Fi Backup Network for private CBRS 5G network. In some embodiments, one or more special-purpose computing systems may be used to implement the functionality described herein. Accordingly, various embodiments described herein may be implemented in software, hardware, firmware, or in some combination thereof. Host computer system(s) 801 may include memory 802, one or more central processing units (CPUs) 814, I/O interfaces 818, other computer-readable media 820, and network connections 822.

Memory 802 may include one or more various types of non-volatile and/or volatile storage technologies. Examples of memory 802 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 802 may be utilized to store information, including computer-readable instructions that are utilized by CPU 814 to perform actions, including those of embodiments described herein.

Memory 802 may have stored thereon control module(s) 804. The control module(s) 804 may be configured to implement and/or perform some or all of the functions of the systems, components and modules described herein for a method for 5G ATSSS Configured to Make a Wi-Fi Backup Network for private CBRS 5G network. Memory 802 may also store other programs and data 810, which may include rules, databases, application programming interfaces (APIs), software platforms, cloud computing service software, network management software, network orchestrator software, network functions (NF), AI or ML programs or models to perform the functionality described herein, user interfaces, operating systems, other network management functions, other NFs, and the like.

Network connections 822 are configured to communicate with other computing devices to facilitate the functionality described herein. In various embodiments, the network connections 822 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 818 may include a video interface, other data input or output interfaces, or the like. Other computer-readable media 820 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for using Wi-Fi as backup for a CBRS private 5G network, the method comprising:
using Access Traffic Steering, Switching and Splitting (ATSSS) to map a first portion of traffic between User Equipment (UE) to a 3GPP Citizens Broadband Radio Service (CBRS) 5G access, and to map a second portion of traffic between UE to a non-3GPP Wi-Fi access;
creating a Multi-Access Protocol Data Unit (MA-PDU) session using ATSSS between the UE and a User Plane Function (UPF) through the 3GPP CBRS 5G access and between the UE and the UPF through the non-3GPP Wi-Fi access;
implementing ATSSS load balancing between the 3GPP CBRS 5G access and the non-3GPP Wi-Fi access to control traffic congestion; and
initiating one of a plurality of ATSSS steering modes to define a primary access network and a backup access network, wherein in response to the primary access network becoming unavailable, traffic automatically switches to the backup access network to maintain operation, and wherein in response to the primary access network becoming available again, the traffic maps back to the primary access network,
wherein the primary access network is one of the 3GPP CBRS 5G access and the non-3GPP Wi-Fi access, and the backup access network is the other of the 3GPP CBRS 5G access and the non-3GPP Wi-Fi access.

2. The method of claim 1, wherein traffic for Ultra-Reliable Low Latency Communications (URLLC) and Internet of Things (IoT) is mapped to 3GPP CBRS 5G access, and wherein the traffic for voice communications and Short Message Service (SMS) is mapped to non-3GPP Wi-Fi access.

3. The method of claim 1, wherein the MA-PDU session is created using ATSSS between a UPF and UE through the 3GPP CBRS 5G access and the non-3GPP Wi-Fi access with a Multipath Transmission Control Protocol (MP-TCP), a Multipath Quick User Datagram Protocol (MP-QUIC), or Access Traffic Steering, Switching and Splitting lower layer (ATSSS-LL) functionalities.

4. The method of claim 1, wherein Multipath QUIC multiplexes application streams on a single UDP flow, and MP-TCP splits a single stream on multiple TCP subflows.

5. The method of claim 1, wherein ATSSS steering mode is used to load balance for traffic for congestion control between the 3GPP access and the non-3GPP access.

6. The method of claim 1, wherein the plurality of ATSSS steering modes include active-standby, smallest delay, and priority based.

7. The method of claim 1, wherein the non-3GPP Wi-Fi access connects via a Non-3GPP InterWorking Function (N3IWF) that acts as a secure gateway with support for N2 and N3 interfaces.

8. A system for using Wi-Fi as backup for CBRS private network, the system comprising:
a memory that stores computer-executable instructions; and
a processor that executes the computer-executable instructions and causes the processor to:
use Access Traffic Steering, Switching and Splitting (ATSSS) to map a first portion of traffic from User Equipment (UE) to a 3GPP Citizens Broadband Radio Service (CBRS) 5G access, and to map a second portion of traffic from UE to a non-3GPP Wi-Fi access;
create a Multi-Access Protocol Data Unit (MA-PDU) session using ATSSS between the UE and a User Plane Function (UPF) through the 3GPP CBRS 5G access and between the UE and the UPF through the non-3GPP Wi-Fi access;
implement ATSSS load balancing between the 3GPP CBRS 5G access and the non-3GPP Wi-Fi access to control traffic congestion; and
initiate one of a plurality of ATSSS steering modes to define a primary access network and a backup access network, wherein in response to the primary access network becoming unavailable, traffic automatically switches to the backup access network to maintain operation, and wherein in response to the primary access network becoming available again, the traffic maps back to the primary access network.

9. The system of claim 8, wherein traffic for Ultra-Reliable Low Latency Communications (URLLC) and Internet of Things (IoT) is mapped to 3GPP access, and wherein the traffic for voice communications and Short Message Service (SMS) is mapped to non-3GPP access.

10. The system of claim 8, wherein the MA-PDU session is created using ATSSS between a UPF and UE through the 3GPP access and the non-3GPP access with a Multipath Transmission Control Protocol (MP-TCP), a Multipath Quick User Datagram Protocol (MP-QUIC), or Access Traffic Steering, Switching and Splitting lower layer (ATSSS-LL) functionalities.

11. The system of claim 8, wherein the primary access network is one of the 3GPP CBRS 5G access and the non-3GPP Wi-Fi access, and the backup access network is the other of the 3GPP CBRS 5G access and the non-3GPP Wi-Fi access.

12. The system of claim 8, wherein ATSSS steering mode is used to load balance for traffic congestion control between the 3GPP access and the non-3GPP access.

13. The system of claim 8, wherein the plurality of ATSSS steering modes includes active-standby, smallest delay, and priority based.

14. The system of claim 8, wherein the non-3GPP access connects via a Non-3GPP InterWorking Function (N3IWF) that acts as a secure gateway with support for N2 and N3 interfaces.

15. A non-transitory computer-readable storage medium having computer-executable instructions stored thereon that, when executed by a processor, cause the processor to:
use Access Traffic Steering, Switching and Splitting (ATSSS) to map a first portion of traffic from User Equipment (UE) to a 3GPP Citizens Broadband Radio Service (CBRS) 5G access, and to map a second portion of traffic from UE to a non-3GPP Wi-Fi access;
create a Multi-Access Protocol Data Unit (MA-PDU) session using ATSSS between the UE and a User Plane Function (UPF) through the 3GPP CBRS 5G access and between the UE and the UPF through the non-3GPP Wi-Fi access;
implement ATSSS load balancing between the 3GPP CBRS 5G access and the non-3GPP Wi-Fi access to control traffic congestion; and
initiate one of a plurality of ATSSS steering modes to define a primary access network and a backup access network, wherein in response to the primary access network becoming unavailable, traffic automatically switches to the backup access network to maintain operation, and wherein in response to the primary access network becoming available again, the traffic maps back to the primary access network.

16. The non-transitory computer-readable storage medium of claim 15, wherein traffic for Ultra-Reliable Low Latency Communications (URLLC) and Internet of Things (IoT) is mapped to 3GPP access, and wherein the traffic for voice communications and Short Message Service (SMS) is mapped to non-3GPP access.

17. The non-transitory computer-readable storage medium of claim 15, wherein the MA-PDU session is created using ATSSS between a UPF and UE through the 3GPP access and the non-3GPP access with a Multipath Transmission Control Protocol (MP-TCP), a Multipath Quick User Datagram Protocol (MP-QUIC), or Access Traffic Steering, Switching and Splitting lower layer (ATSSS-LL) functionalities.

18. The non-transitory computer-readable storage medium of claim 15, wherein the primary access network is one of the 3GPP CBRS 5G access and the non-3GPP Wi-Fi access, and the backup access network is the other of the 3GPP CBRS 5G access and the non-3GPP Wi-Fi access.

19. The non-transitory computer-readable storage medium of claim 15, wherein ATSSS steering mode is used to load balance for traffic for congestion control between the 3GPP access and the non-3GPP access.

20. The non-transitory computer-readable storage medium of claim 15, wherein the plurality of ATSSS steering modes includes active-standby, smallest delay, and priority based, and wherein the primary access network is the 3GPP access and the backup access network is a non-3GPP access.
